(19) United States
(12) Patent Application Publication
(10) Pub. No.: US 2007/0034232 A1
(43) Pub. Date: Feb. 15, 2007

(54) Compact disc buffer system

(76) Inventor: Daniel Diotte, Webster, MA (US)

Correspondence Address: OUR PAL ASIJA;ASIJA HOUSE, 7 WOONSOCKET AVENUE, SHELTON, CT, 06484-5536, US

(21) Appl. No.: 11/103,234

(22) Filed: Apr. 11, 2005

Related U.S. Application Data
(60) Provisional application No. 60/561,596, filed on Apr. 12, 2004.

(51) Int. Cl. B08B 1/04

(52) U.S. Cl. 134/6; 15/102; 15/77; 15/88.3

(57) ABSTRACT

This invention comprises methods, devices, and systems for buffing, to repair and restore all types of compact discs. The restoration is essentially accomplished by interaction of rotating buffers with a compact disc on a rotating platform. For added effectiveness certain chemicals are added to the rotating buffers. The portable system is fully automatic such that an operator can perform other functions. The device also includes plurality of timers and indicators as well as a convenient carrying handle. The CD Buffing Unit allows the restoration and maintenance of all known CD Media, DVDs, single or double sided, including 3-inch discs with the use of a 3-inch adapter.

### RELATED DOCUMENT

This non-provisional utility application is based upon provisional application Ser. No. 60/561,596 filed Apr. 12, 2004 bearing the same title, “Compact Disc Buffer System” by the same inventor Dan Diotte and the inventor applicant hereby claims priority there from.

### BACKGROUND

This invention relates generally to a restoration system. More particularly it relates to a device that buffs compact discs in every format. Even more particularly it relates to methods, devices and system that effectively repair the optical surface of a compact disc.

### THE PROBLEM

Compact discs often get scratched. Various machines, methods and processes have been devised and constructed to repair such discs such that data can be rerecorded and faithfully reproduced. The problem with prior art techniques can be categorized into the following:

Unable to record and reproduce data faithfully.

a) Not cost effective.

b) Results in waste.

c) Raises environmental concerns.

d) Not easy to install, use and operate.

e) Existing machines remove material therefore the number of repair cycles on any one disc is limited.

### SUMMARY

Compact discs often get scratched with use or accidentally. When this happens music discs skip tracks and DVDs skip frames, which interferes with proper education and entertainment. Instead of investing in a new disc, this invention comprises methods, devices, and systems for buffing to repair and restore all types of compact discs.

The CD Buffing Unit allows the restoration and maintenance of all known CD Media, DVDs, single or double sided, including 3 inch discs with the use of a 3-inch adapter. The device essentially comprises interaction of rotating buffers with a compact disc on a rotating platform. For added effectiveness certain chemicals are added to the rotating buffers. Discarding the scratched CD is obviated by loading the scratched CD onto a rotating platter mechanism and buffed on the optical side of the CD by the inner action of a motor, turning buffing pads and the application of liquid between the pads and the optical side of the CD.

The process eliminates a large portion of optical defects, caused by scratches or scuffs. This buffing process causes a heat build up between the pads and the CD media, which effectively re-flows or pushes or relocates the plastic, allowing the optical surface to be freed from optical defects, therefore restoring the playability and accessibility of CD data. This process, with the aid of the liquid, to control heat build-up, allows a non-aggressive approach to repairing the optical side of a CD without removing any polymers off the CD, or affecting its thickness. Resulting in virtually an unlimited amount of times a CD can be maintained or repaired.

### PRIOR ART

A preliminary prior art patent search was conducted by the applicant. Furthermore the applicant is intimately familiar with the prior art. Prior art inventors have been very creative in designing exotic tables but are seldom successful in combining strength and elegance. Following is a survey of the prior art patents and publications arranged in reverse chronological order for ready reference of the reader.

2) U.S. Utility Pat. No. 6,386,946 blessed upon Lin et al on May 14, 2002 for “Repair Machine for Compact Disk”

1) U.S. Utility Pat. No. 5,954,566 awarded to Jason Bauer on Sep. 21, 1999 for “Method and Apparatus for Reconditioning Digital Recording Discs”

Objectives

At any rate none of the prior art devices known to the applicant or his attorney disclose the EXACT embodiment of this inventor that constitutes a simple, elegant, quick, convenient, affordable means of constructing this invention. Prior art devices do not provide singularly or even in combination all of the objectives as established by the inventor for this system as enumerated below.

It is an objective of this invention to provide a system for quickly and effectively repairing or maintaining all types of scratched or otherwise damaged compact discs.

Another objective of this invention is to provide a one step, fully automated way to repair a compact disc, in a convenient and short period of time having no noticeable characteristics of being repaired, such that the lack of noticeable characteristics would give the CD, an indistinguishable new look.

Another objective of this invention to provide a perfect restoration through buffing the polymers optically clear. That inherently would not affect the thickness or the amount of times the CD could be maintained or repaired.

Another objective of this invention is to obviate the need to grind, sand, lap, or cut, using several aggressive methods or processes on the optical surface in order to achieve optical clarity and esthetics.

Another objective of this invention is to eliminate air-born and chemical pollutants due to conventional chemical compound grinding, sanding, and lapping techniques.

Another objective of this invention is that the device be portable to operate as front counter device as opposed to a back-office operation.

Another objective of this invention is to not affect the thickness of the CD and/or the amount of times the said media can be maintained.

Another objective of this invention is that the design is simple and elegant.

Another objective of this invention is that its use is intuitive, which requires no further training.

Another objective of the system of this invention is that it be capable of multiple uses.

Another objective of the invention is that it uses little or no additional energy by obviating any wiping, polishing, or clean up by hand, after the repair is complete.

Another objective of this invention is that the invention use modular standard components, easily interface-able, transportable, and storable.

Another objective of this invention is that it be reliable such that it practically never fails and requires very little maintenance. (Every 2500 cycles—cleaning and buffing pads only)

Another objective of this invention is that it be environmentally friendly, and uses biodegradable materials to the extent practical.

Another objective of this invention is that it be physically safe in normal environment as well as accidental situations.

Another objective of this invention is that it be made long lasting, made from durable materials.

Another objective of this invention is to provide a cheap consumable alternative to maintenance or repair of a CD. (Up to ten times less in consumable costs)

Another objective of this invention is that it provides 2500 repeatable processes before consumable change.

Another objective of this invention is that it provides the majority of repairs or maintenance to a CD in 30 seconds.

Another objective of this invention is to provide a user friendly, smart interface with the user.

Another objective of this invention is that it be interface-able with other electronic devices through software and hardware add-ons and up-grades.

Another objective of this invention is that the device can acclimate software up-grade and/or hardware device add-ons, options, and up-grades.

Another objective of this invention is to provide an application of the liquid or coolant in a manual and or automated disbursement over the optical side of the CD media.

Another objective of the invention is to provide the majority of the mechanical apparatus in an interchangeable module for end user replacement of mechanical parts.

Another objective of this invention is that it meet Federal, State, local, and other private, international, standard guidelines, regulations, compliances and recommendations with respect to safety, environment, and energy consumption.

Another objective of this invention resides in its simplicity, elegance of design, ease of manufacturing, service and use and even aesthetics as will become apparent from the following brief description of the drawings and the detailed description of the concept embodiment.

Other objectives of this invention reside in its simplicity, elegance of design, ease of manufacture, service and use and even aesthetics as will become apparent from the following brief description of the drawings and the detailed description of the concept embodiment. Unfortunately none of the prior art devices singly or even in combination provide all of the features established by the inventor for this system as enumerated below.

a) Safe, Secure, Simple and elegant sleek design

b) Affordable and Cost effective

c) Easy to manufacture, use and operate and maintain.

e) Small Foot Print with Center of Gravity within base.

f) User Friendly and intuitive.

g) Long lasting and durable

h) Intuitive to require no additional training

i) Multiple uses in a wide range of situations and circumstances.

j) Easily scaleable up and down

k) Easily adaptable for other uses

l) Environmentally friendly

m) Unlimited repair cycles as no material is removed from the CD.

### BRIEF DESCRIPTION OF DRAWINGS

These objectives and features of the invention shall now be described in relationship to the following drawings, which are integral part of the specifications and are incorporated herein.

FIG. 1 is a 3-D isometric exterior view of the CD Buffer.

FIG. 2A is an interior sectional view of the mechanisms of the CD Buffer. Likewise FIG. 2 B shows more detailed top plan view of the rotating CD platter and the buffer motor travel means. It effectively shows an enlarged view of lower section of FIG. 2A for clarification.

FIG. 3 is a 3-D isometric view the inner action between the motorized buffing wheels or pads, the coolant liquid, and the optical side of the CD media.

FIG. 4 shows a process flow chart.

FIG. 5 depicts a software program flowchart.

FIG. 6 delineates a low voltage schematic of the CD Buffer used by the inventor in the preferred embodiment.

FIG. 7 delineates a high voltage schematic used by the inventor in the preferred embodiment.

FIG. 8 shows an enlarged cross-sectional view of the disc and how the lasers interact with the data layer at the bottom of the disc for read and write operations.

### DETAILED DESCRIPTION OF THE BEST MODE PREFERRED EMBODIMENT

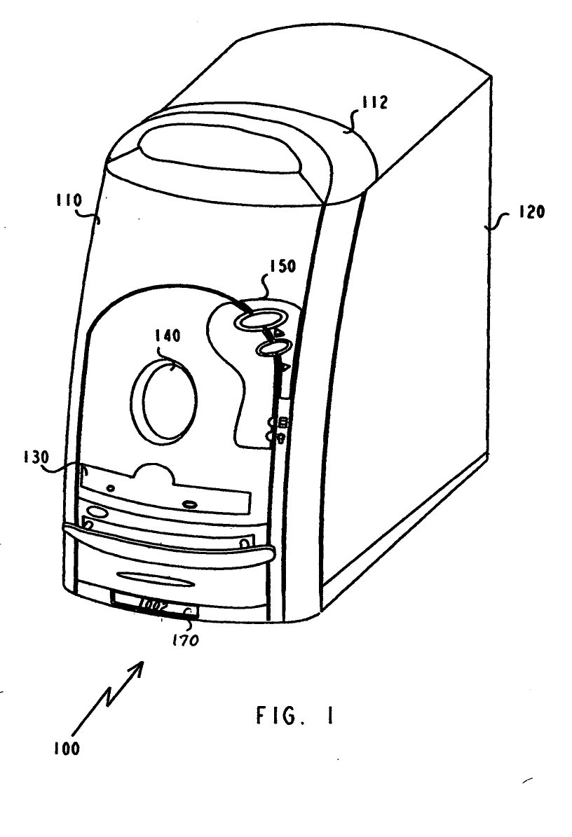

As shown in the drawings wherein like numerals represent like parts throughout the several views, there is generally disclosed in FIG. 1 is a 3-D isometric exterior view of the CD Buffer, complete with front panel 110, convenient carrying handle 112, removable side panels 120, CD access 130, view window 140 and plurality of status indicators 150. FIG. 1 shows an isometric view of the entire external embodiment of the CD Buffer 100, which comprises of a front portion 110, a top portion with handle 112. A removable side portion 120, a drawer and handle portion 130, a Cyclops eye portion 140, a control panel 150, deep buff panel 160, numeric counter display 170. More specifically the front portion 110, includes Cyclops eye with a multi-phasic color LED display 140, a control panel with an open button, start button, green power-on LED light, blue LED process-in-operation light 150, a deep buff panel consisting of a deep-buff-selector button, and a red LED deep buff indicator light 160. A door and handle portion consisting of a front door and attached handle 130. A numeric LCD counter display 170.

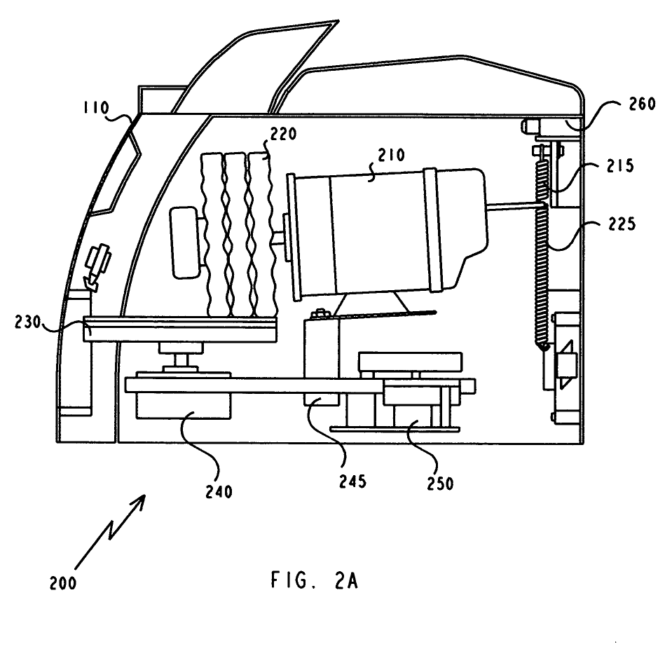

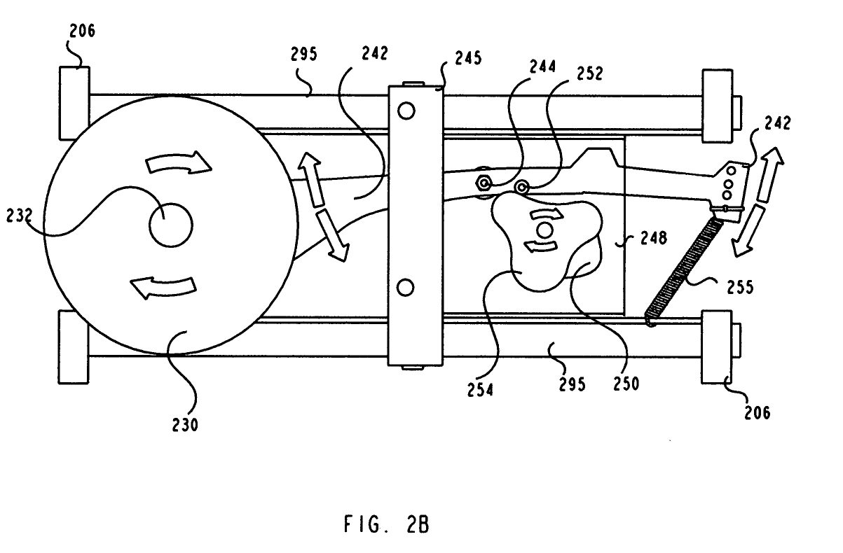

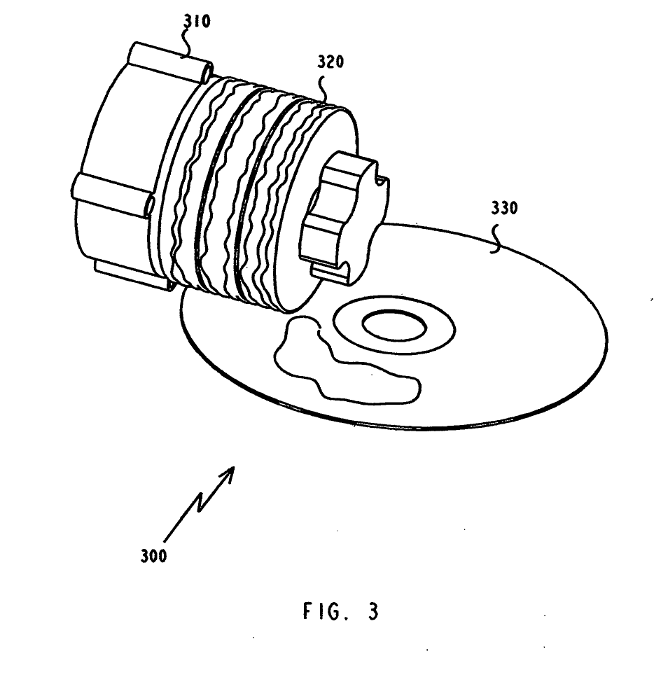

FIG. 2A depicts an interior sectional view of the mechanisms of the CD Buffer complete with front panel 110, motor 210, spring 215, rotating buffers 220, rotating CD platter 230, platter motor 240, Interface 245 between two said motors and floating platform 250 for said two motors. FIG. 2 is a cut sectional view exposing the preferred embodiment of the interior CD Buffer mechanisms 200, which comprises of a sub-frame 205, an AC motor 210, Buffing pads 220, a CD platter table 230, a CD platter motor 240, a cam motor 250, motor lift spring 215, motor lift solenoid 260, latch-tray solenoid (Not shown), high power AC board 280, low power PLC controller board 290, sliding drawer rails 295, Air-pot cylinder 265. Neopream is added on the CD platter for added traction so as to act as a cushion and break such that its 120-RPM motor does not race towards 2500 RPM.

More specifically an AC Motor 110/220 Volts, ⅓ Horsepower, 3500 RPM 210. Comprising of a rear portion 212, and attached to the rear portion is an angle spring bracket 214, which is connected to the motor lift spring 215. Also comprising of a front shaft portion 216, which 3 buffing pads are slid on to 220, 221, 222. The 3 pads are evenly spaced by two rubber spacers ⅜ of an inch thick and two-inch diameter 225. The pads and spacers are held in place by knob (not shown). The AC motor is held in place by mounting bracket 245, which is pivotally attached to drawer slide-rail assembly 295. Drawer slide-rail assembly 295, has attached to it Cam base plate 248, which has mounted on it a 20 RPM AC or DC Cam motor 250. Which has attached to it a Cam 251 with 3 distinct protrusions. The Cam 251 is connected to a track-roller bearing 252 that follows the curvature of the cam. The track-roller bearing 252 is connected to the cam lever arm 242 which is spring loaded by spring 253 which spring loads the track-roller 252 against Cam 251. The Cam lever arm is held in place by bearing and bolt assembly 243, which allows the Cam lever arm 242 to pivot in a side to side motion caused by the spring loaded interaction or tracking between the track-roller bearing 252 and the Cam 254. Also attached to the Cam lever arm 242 is a 120-RPM, AC or DC CD platter motor 240. Attached to the motor shaft is a 4 ¾ inch CD platter 230. Which consists of the main platform 230, the center pin 232 for a CD, and a soft 50 duro or less, neopream, and adhesive backed rubber. Also shown in FIG. 1 motor lift solenoid 260 aided by push pull pair of springs 215, 225.

FIG. 2 B shows more detailed top plan view of the rotating CD platter and the buffer motor travel means. It effectively shows an enlarged view of lower section of FIG. 2A for clarification. For further clarification it shows in greater detail the top plan view of the sub-frame assembly 205, concomitant slide rail assembly support member 206, motor position bracket 245, buffer motor travel means 250, cam base plate 248, cam lever arm 242 and concomitant spring 255. Attached is a 110/220 AC lift solenoid 260. Attached to the solenoid arm 264 is the motor lift spring 215, which has a load spring capacity of 3 pound after one inch of travel. Spring 215 is connected to Angle Spring bracket (not shown).

The AC Lift Solenoid 260 is activated by retracting it's Solenoid Arm upwards, effecting the pulling of spring 215, 216. This causes the AC Motor 210 to tilt forward by upward driven motion. The deactivation of the AC Lift Solenoid 260 causes through natural gravity a slow and controlled decent of motor 210. In the preferred embodiment the controlled decent is approximately 15 seconds to traverse the 1- 1/16 of an inch downwards. This entire Lift solenoid sub-assembly controls the activation, deactivation and pressure of rotating pads 220 with Compact disc media 231, which is a-fixed to Platter 230. The Cam Lever Arm Assembly starts with sub-frame 205. Attached to it are two drawer rail brackets 206.

Cam Motor 250 spins at 20-RPM Counter clockwise. Cam 251 has six distinct quadrants, three inward quadrants of the same depth of approximately 1 inch from the center of the Cam 254. Three outward protruding quadrants that are effectively doubling in distance and range of motion from the starting point of an inward quadrant. The smallest outward protrusion of approximately ¼ inch, the second outward protrusion ½ inch, and the third and largest outward protrusion is ¾ of an inch from inward quadrant.

This Cam 254 is followed by bearing track roller 252, which is tensioned against the Cam with the aid of spring 255. As the Cam rotates counter clockwise it effectively moves the track-roller bearing 252 attached to Cam Lever Arm 242, which pivots on the center point bearing and bolt assembly 243. This effectively moves the CD platter 230 perpendicular to the AC Motor 210. The range of motion is as follows Pads 220 to 222 and shaft 216 is lined up with CD Mounting Pin 232. The Cam Lever Arm 242, and the CD Platter 230 spinning at 120 RPM, pivots it's self away from the pads 220 approximately two inches, due to the motion of the largest outward protrusion of the Cam 251 pushing on the Track-roller bearing 252.

The CD Platter 230 and Cam Lever Arm 242 swings 180 degrees in the opposite direction towards the Pads 220, coming to rest 1 inch from its original starting position. Center Pin 232 is approximately 1 inch from center of Pads 220. The next range of motion again, reverses the direction 180 degrees to force the CD Platter 230 to move away from pads 220, approximately 1 inch for a total traverse distance of 2 inches from the original centering point of Pads 220. This represents the mid-furthest protrusion of Cam 254.

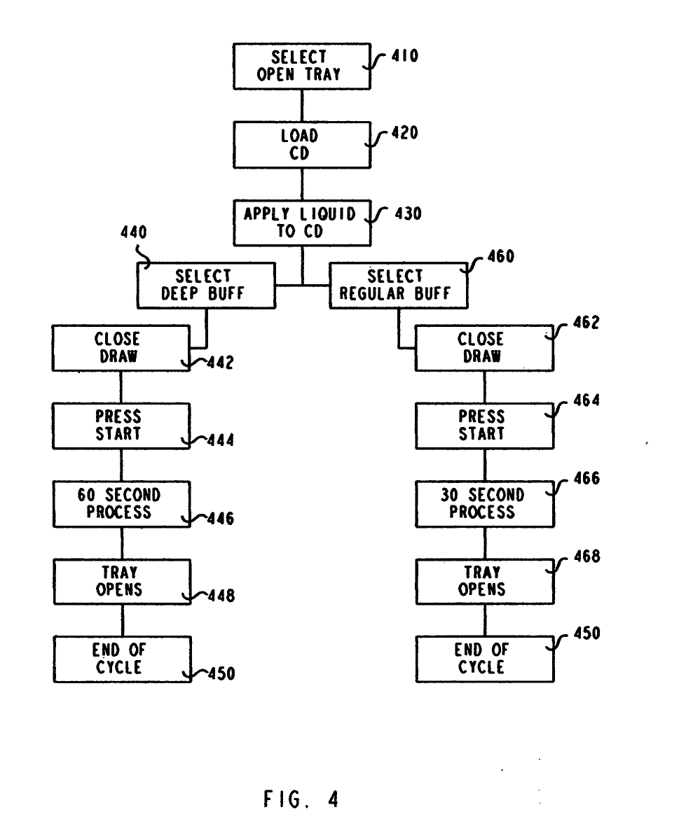

The third and final range of movement is represented by the smallest protrusion on Cam 254, which traverses the Lever Arm 242 and the CD Platter 230 to go towards the pads 220 to 222 half of an inch. Again, the motion continues 180 degrees away from the pads 220, in the opposite direction another one half inch to have a total combined distance of two inches between Pads 220 and the Centering Pin 232. The final traverse distance will reverse 180 degrees, and travel two inches to line the Cam Lever Arm 242, CD Platter 230, and Centering Pin 232 with Pads 220, and AC Motor 210. This range of motion is specifically designed to distribute an even dispersion of force, friction and heat to the CD media 231. More specifically, if you apportion the record-able area of CD media 231 into three quadrants with an interior quadrant area and an exterior quadrant area and a center quadrant area, the interior quadrant area has only one third the surface area as the exterior quadrant area or in contrast the exterior quadrant area has three times the physical surface area. The range of movement produced by the Cam 254 concentrates in a time sequence, three times as much frictional buffing on the exterior quadrant than the interior quadrant and vise versa. This produces an even heat transfer and distribution, between the Pads 220, the Coolant 340 and compact disc media 231, shown in FIG. 3, producing an even re-flowing of the plastic in a controlled, uniform manner to effectively re-flow the immediate top layer surface of the optical side of the compact disc media 231. This range of movement prevents ill effects to the CD media 231 such as warping, rounding of edges, surface degradation, plastic inclusions, due to excessive heat or uneven heat transfer also the lack of heat ineffectively repairing and re-flowing the surface.

FIG. 3 is a 3-D isometric view the inner action between the motorized buffing wheels or pads, the coolant liquid, and the optical side of the CD media specifically delineating in detail buffer motor 310, rotating buffers 320 and rotating platter 330, which in turn comprises of a front portion 310 of AC Motor 210, a Pad grouping of three pads 320 which comprises of 220, the optical side of CD media 231 and coolant 340. More specifically the three pads.

Each pad 220 comprises muslin with 15 layers, chemically treated with Anti-static conditioner coolant, Pad Product number PN#2499, AC Coolant product Number PN. #2099 available from VenMill Industries Inc telephone number 1-508-640-0090, 28 Town Forest Rd., Unit 1, Webster, Mass., 01570, or purchase from web site www.venmill.com Also sold by Distributor: Specialty Store Services 1-800-999-0771, or purchase from web site www.Specialtystoreservices.com. Also available from VenMill Industries Inc., Product Number #2299 and Specialty Store Services. Product Number #8281.

Pad Product number PN#8333, AC Coolant product Number PN. #8334 Pad 220 is a normal concentration of AC liquid coolant 340 that has been approximately dipped in coolant for ten seconds, buffing pads are then spun at 5000 RPM then cut and raked and dried to 5 ½ inches in diameter. Buffing Pad 221 has 50% more concentration of AC Liquid coolant 340 and prepared and finished in the same manner as Buffing Pad 220. Buffing Pad 222 has been treated with double or 100% more concentration of AC Liquid coolant 340, and has been prepared and finished in the same manner as Buffing Pads 220, and 221.

The specific differences in concentrations in Pad group 320 are again to maintain an even control of surface temperature in the distinctive surface areas between the small interior surface area to the largest exterior optical surface area of the CD Media 231. The coolant 340 dissipates with the mechanical friction of Pad Group 320 against the CD Media 231 leaving no residual on the surface of the CD Media 231.

Build up of residual residue of Coolant 340 is apparent after ten to twenty operations on Pad Group 320. In order to maintain peak performance of Pad Group 320 the residual is raked off by running a CD cleaner Disc in place of the CD Media 231. This Cleaner Disc can be run through a 30 second or one minute cycle and has 60 raking teeth, which operate much like a cheese grater. This allows the residual to be detached from Pad Group 320 leaving the Buffing Pads in an original, high performance condition. The CD Cleaner disc Product Number #2399 can be ordered from above mentioned Vendors.

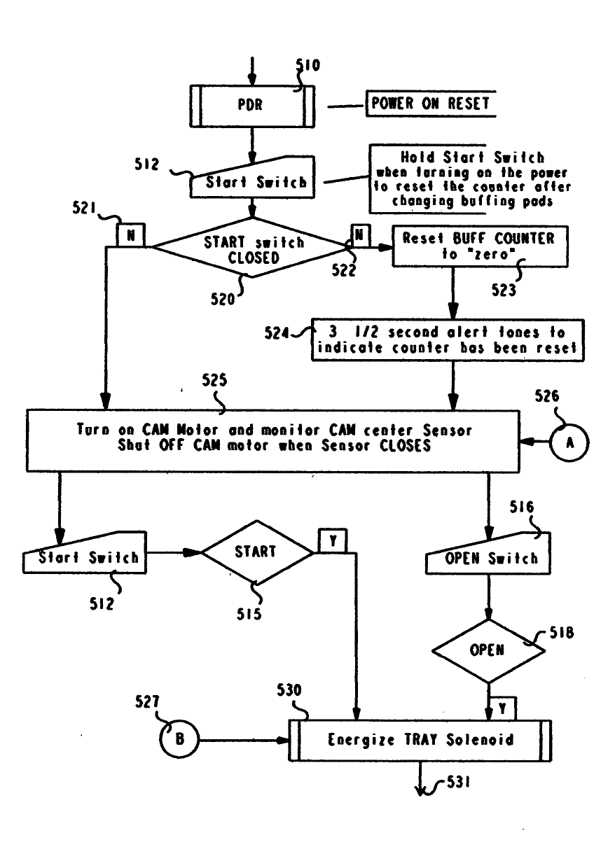

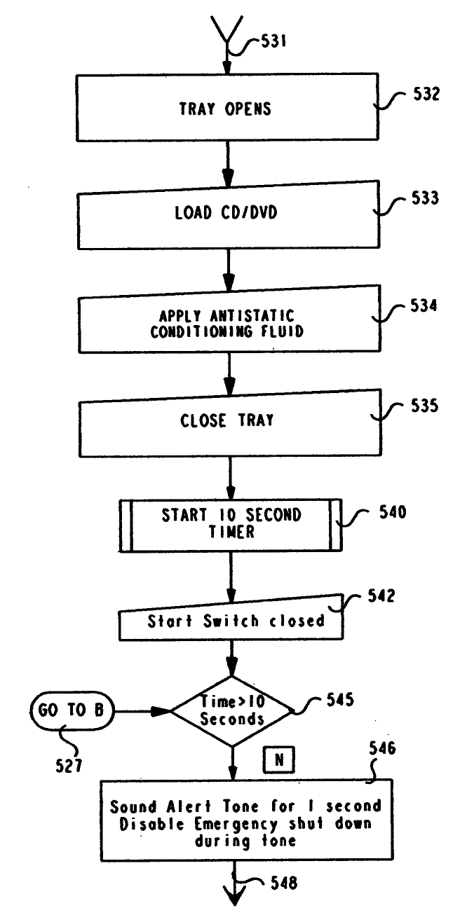

FIG. 4 shows a bifurcated user process flow chart for deep and regular buffs. Once the CD media 231 has been loaded on to the CD Platter 230 with a surface application of coolant 340 applied to the entire surface of the record-able area of the optical side of the CD media 231, opposite to label side, the process starts with the Motor 210, 240 and 250 starting then the solenoid 260 lifting AC Motor 210 which tilts pads 220 onto the CD Media 231. The Solenoid 260 will stay activated for fifteen seconds then release with a slow, controlled decent, for an additional fifteen seconds, slowly releasing the pressure of Pads 220 off the CD Media 231 giving it a high, indistinguishable surface shine, like new. Then Motor 210, 240 and 250 shut off. This is a one-step process, not adding or removing any materials from the optical surface of the Compact disc media 231.

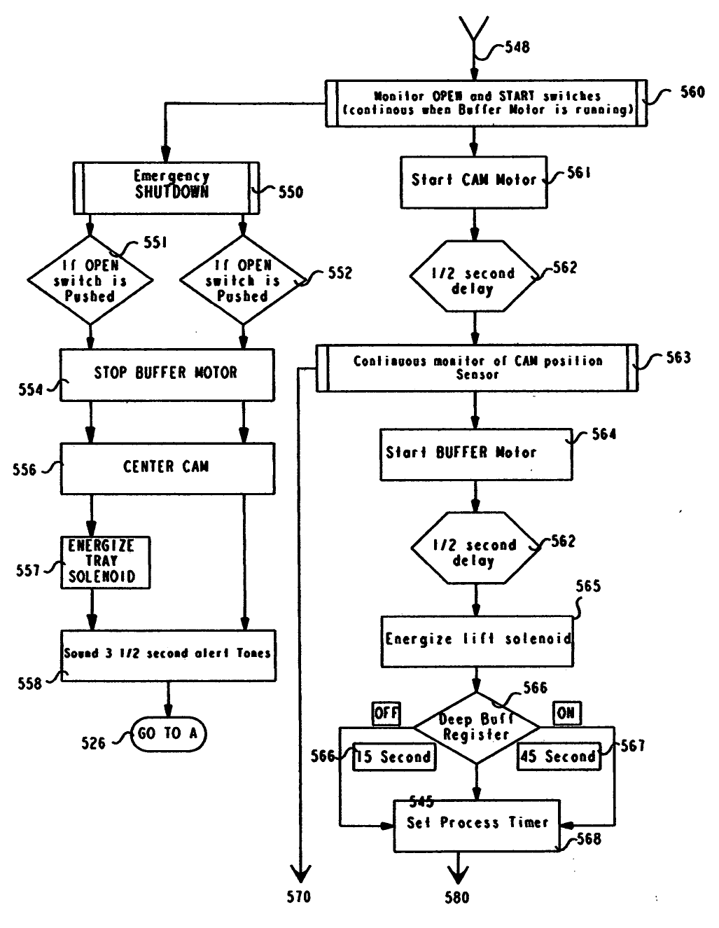

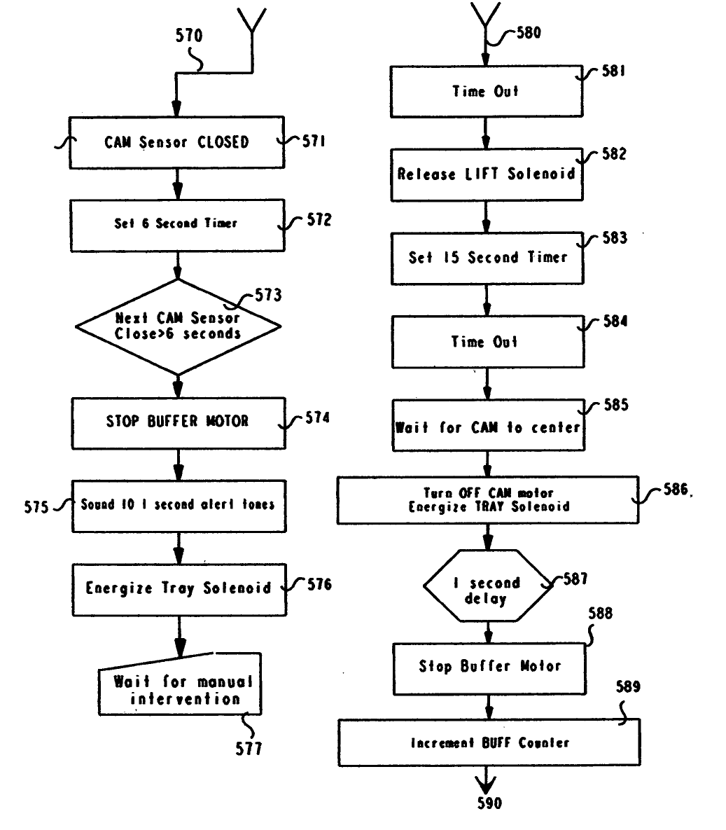

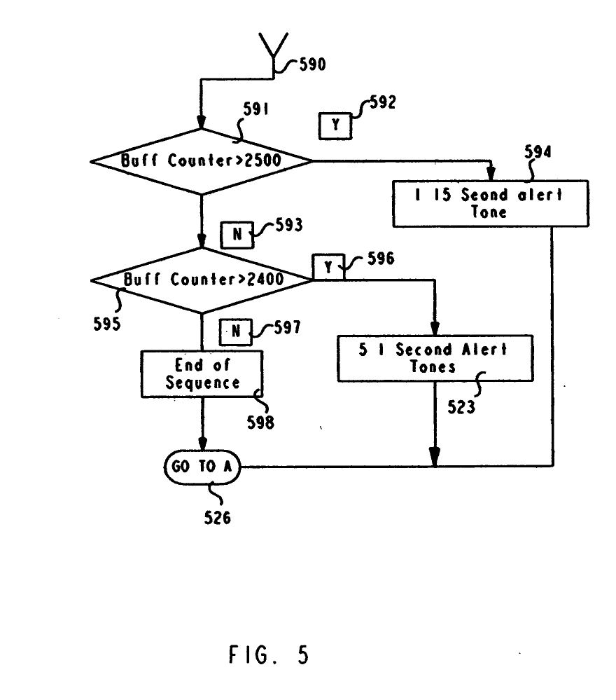

FIG. 5 depicts a software program flowchart spread over 5 sheets complete with plurality of interpage connectors, plurality of decision blocks, plurality of GOTO Connectors with alpha nomenclature.

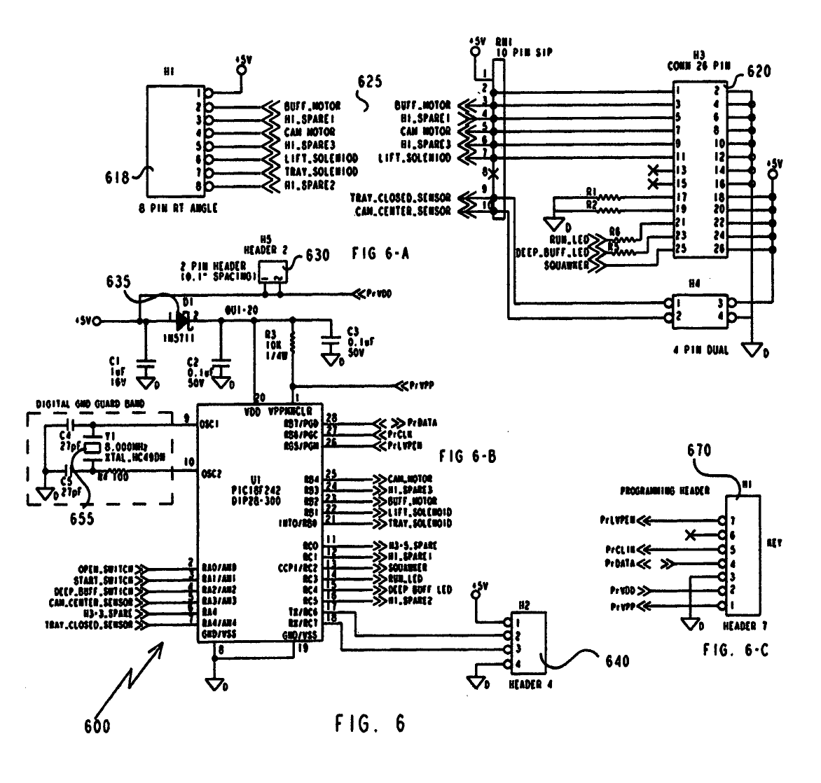

FIG. 6 delineates a low voltage schematic of the CD Buffer used by the inventor in the preferred embodiment complete with plurality of integrated circuit chips 620, 650, plurality of programming headers 630, 640 and intermodule connector 625 and associated supporting components such as crystal 655 and bi-directional rectifier 635

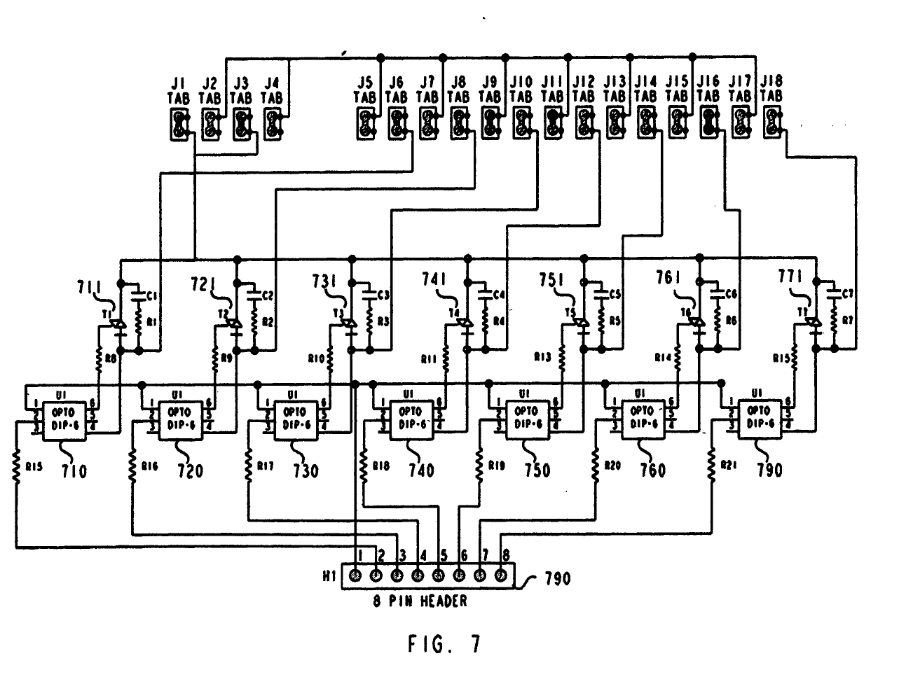

FIG. 7 delineates a high voltage schematic used by the inventor in the preferred embodiment complete with plurality of OPTO DIP circuits 710, 770 each with supporting circuitry 711, 771 respectively and plurality of connectors 780, 790.

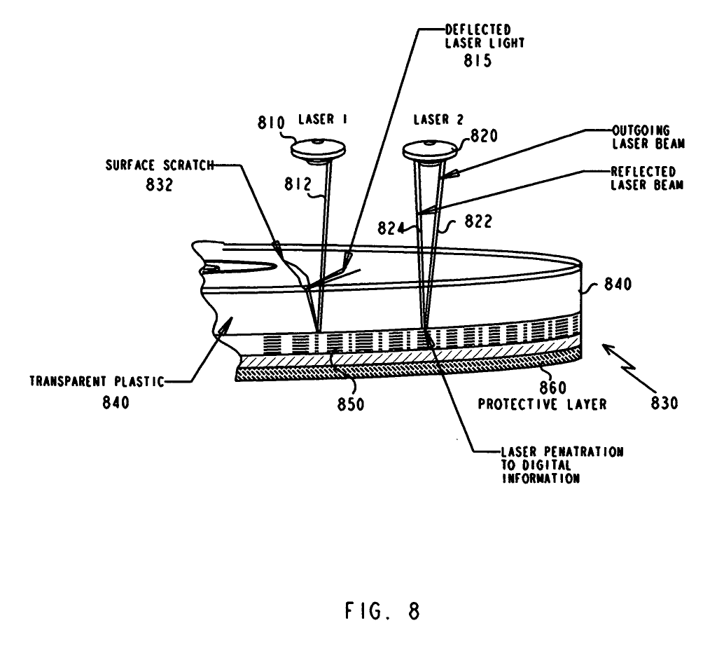

FIG. 8 shows an enlarged cross-sectional view of the disc and how the lasers interact with the data layer at the bottom of the disc for read and write operations. It basically delineates the theory of operation and why buffering not only does not delete the data but restores it.

When a compact disk 99 is scratched instead of discarding the CD, it is loaded onto a platter mechanism 230 and buffed on the optical side of the CD 330 by the interaction of a motor 210, 310, turning buffing pads 320, the application of liquid between the pads 220, 320 and the optical side of the CD 330.

The inventor employed the following program in the preferred embodiment but other programs in other languages and other platforms can also work satisfactorily.

CCS PCH C Compiler, Version 3.182, 19488 Filename: C:\VenMill_v10.LST

ROM used: 5840 (38%) Largest free fragment is 9708

RAM used: 82 (11%) at main( ) level 160 (21%) worst case

Stack: 14 worst case (8 in main+6 for interrupts)

0000: GOTO 13F8

0008: MOVWF 05

000A: MOVFF FD8, 06

000E: MOVF FE9, W

0010: MOVWF 07

0012: MOVF FEA,W

0014: MOVWF 08

0016: MOVF FE1,W

0018: MOVWF 09

001A: MOVF FE2,W

001C: MOVWF 0A

001E: MOVF FD9,W

0020: MOVWF 0B

0022: MOVF FDA,W

0024: MOVWF 0C

0026: MOVF FF3,W

0028: MOVWF 14

002A: MOVF FF4,W

002C: MOVWF 15

002E: MOVF FE0,W

0030: MOVWF 0D

0032: MOVLB 0

0034: MOVF 00,W

0036: MOVWF 0F

0038: MOVF 01,W

003A: MOVWF 10

003C: MOVF 02,W

003E: MOVWF 11

0040: MOVF 03,W

0042: MOVWF 12

0044: MOVF 04,W

0046: MOVWF 13

0048: BTFSS FF2.5

004A: GOTO 0054

004E: BTFSC FF2.2

0050: GOTO OBD6

0054: BTFSS F9D.0

0056: GOTO 0060

005A: BTFSC F9E.0

005C: GOTO 0C32

0060: BTFSS FF2.4

0062: GOTO 006C

0066: BTFSC FF2.1

0068: GOTO 00B2

006C: GOTO 0C64

0070: MOVF 0F,W

0072: MOVWF 00

0074: MOVF 10,W

0076: MOVWF 01

0078: MOVF 11,W

007A: MOVWF 02

007C: MOVF 12,W

007E: MOVWF 03

0080: MOVF 13,W

0082: MOVWF 04

0084: MOVF 0D,W

0086: MOVWF FE0

0088: BSF 0D.7

008A: MOVF 07,W

008C: MOVWF FE9

008E: MOVF 08,W

0090: MOVWF FEA

0092: MOVF 09,W

0094: MOVWF FE1

0096: MOVF 0A,W

0098: MOVWF FE2

009A: MOVF 0B,W

009C: MOVWF FD9

009E: MOVF 0C,W

00A0: MOVWF FDA

00A2: MOVF 14,W

00A4: MOVWF FF3

00A6: MOVF 15,W

00A8: MOVWF FF4

00AA: MOVF 05,W

00AC: MOVFF 06,FD8

00B0: RETFIE 0

. . . File: VenMill_V10.C

. . . Type: C program Source Code

. . . Date: 07-23-03

. . . Rev: 1.0 Original port to CCS compiler

. . . By: WMD

. . . Target: PIC18F242 microcontroller

. . . Desc:

. . . Include header files

Assembly Use and Opporation

The process eliminates a large portion of optical defects, caused by scratches or scuffs. This buffing process causes a heat build up between the pads and the CD media which effectively re-flows or pushes or relocates the plastic, allowing the optical surface to be freed from optical defects, therefore restoring the playability and accessibility of CD data. This process, with the aid of the liquid, to control heat build-up, allows a non-aggressive approach to repairing the optical side of a CD without removing any polymers off the CD, or affecting its thickness. Resulting in virtually an unlimited amount of times a CD can be maintained or repaired.

The manufacturing, assembly and use of this invention is very simple even intuitive. Nonetheless the inventor suggests the following procedure.

a) Loading damaged compact disc onto a platter mechanism.

b) Applying coolant onto optical side of CD manually or in an automated disbursement.

c) Engaging, rotating, buffing wheels or pads to have direct contact with the optical side of the CD and the coolant.

NOTE: The direct contact results in heat build-up causing the re-flowing of the polymers of the optical surface of the compact disc media. The direct contact of said pads slowly elevates towards the end of the cycle to a non-contact state with the CD media, producing an indistinguishably like-new polished shine.

d) Removing the CD media from the platter mechanism and putting directly back into service without any further effort, work, or finishing processes.

The inventor has given a non-limiting description of the system of this invention. Due to the simplicity and elegance of the design of this invention designing around it is difficult. Nonetheless many changes may be made to this design without deviating from the spirit of this invention. Examples of such contemplated variations include the following:

a) The shape and size, thickness and material used in the buffing pads may be modified.

b) The color, aesthetics and materials may be enhanced or varied.

c) Additional complimentary and complementary functions and features may be added.

d) A more economical version and/or size of the device may be adapted.

e) The device may be operated manually or powered by a different energy source.

f) The speeds and strokes of motors and various lever mechanisms may be varied.

g) The coolant may be manually or mechanically applied.

Other changes such as aesthetics and substitution of newer materials as they become available, which substantially perform the same function in substantially the same manner with substantially the same result without deviating from the spirit of the invention may be made.

The following is a brief description of the function of the components used in the best mode preferred embodiment for use with OEM as well as retrofit markets. For the ready reference of the reader the reference numerals have been arranged in ascending numerical order.

100=The closed system, the machine, or the device generally

110=The front panel

112=The Handle

120=Removable side panels

130=Front Loading CD Access Door

140=Observation window

150=Status Indicators

170=Numeric LCD Counter Display

200=The exposed system, the machine, or the device generally

205=Sub Frame assembly

206=Slide Rail Assembly Support Member

210=Buffing Motor

215=Buffer motor lift spring

220=Buffers and/or buffer pads

225=Tensioner spring

230=Rotating CD platter

232=CD platter center pin

240=Rotating platter motor

242=Cam Lever Arm

244=Bearing and bolt assembly to allow cam lever arm 242 to pivot side to side.

245=Buffer motor positioning bracket

248=Cam base plate

250=Buffer motor travel means generally

252=Track roller bearing

254=Cam

255=Spring

260=Motor lift solenoid

295=Drawer slide rail assembly

300=CD Buffer Pads Interface

310=Buffer motor

320=Buffers and/or buffer pads

330=CD platter

400=User process interface generally

410=Operator selects open tray

420=Operator loads CD with optical side face up

430=Operator applies liquid chemical

440=Operator selects deep buff

442=Operator closes door

444=Operator starts automatic process

446=60 second timer

448=CD tray opens automatically

450=End of cycle

460=Operator selects deep buff

462=Operator closes door

464=Operator starts automatic process

466=60 second timer

468=CD tray opens automatically

500=Software program flow chart generally

510=Power on reset

512=Start switch

515=Start operation decision block

516=Open switch

518=Open switch decision block

520=Start switch status decision block

521=Start switch not yet closed

522=Start switch closed

523=Reset Buff counter to 0

524=Reset alarm

525=CAM motor operates as long as CAM center sensor is open

526=A Input/Output (GOTO)

527=B Input/Output(GOTO)

530=Energize tray solenoid

531=Interpage connector #1

532=CD Tray opens

533=Load CD/DVD

534=Application of antistatic conditioning fluid

535=Close tray

550=Ten second timer operation

542=Start switch closed

545=Timer monitor decision block

546=Disable emergency shut down

548=Interpage connector #2

550=Emergency shutdown

551=Open Switch Decision

552=Start Switch Decision

554=Stop buffer motor

556=Center CAM

557=Energize tray solenoid

558=Alarm Tone cadence

560=Monitor Open & Start switches when buffer motor is running

561=Start CAM motor

562=Half second delay

563=Monitor CAM position sensor continuously

564=Start buffer motor

565=Energize lift solenoid

566=Deep Buff Register

566=15 seconds

567=45 seconds

568=Set Process timer

570=Interpage connector #3

571=CAM sensor closed

572=Six second timer

573=CAM sensor Timer Decision

574=Stop buffer motor

575=Ten short Alert Tones

576=Energize tray solenoid

577=Wait for manual intervention

580=Interpage connector #4

581=Time out

582=Release Lift solenoid

583=Set 15 Second Timer

584=Time Out

585=Wait for CAM to center

586=Turn off CAM motor & Energize tray solenoid

587=One second delay

588=Stop buffer motor

589=Increment Buff Counter

590=Interpage connector number 5

591=Buff Counter greater than 2500

592=Buff Counter greater than 2500—YES

593=Buff Counter greater than 2500—NO

594=15 second alert tone

595=Buff Counter greater than 2400

596=Buff Counter greater than 2400—YES

597=Buff Counter greater than 2400—NO

598=End of Sequence

599=Five short alert tones

600=Logic schematic of CD Buffer generally

610=8 Pin connector module

620=26 Pin Integrated Circuit

625=Inter module connecting member

630=2 Pin Header

635=Bi-directional rectifier

650=Microprocessor

655=Crystal for clock frequency control

670=7 Pin terminal module

700=Motor voltage schematic of CD Buffer generally

710=OPTO DIP #1

711=Rectifier circuit #1

720=OPTO DIP #2

721=Rectifier circuit #2

730=OPTO DIP #3

731=Rectifier circuit #3

740=OPTO DIP #4

741=Rectifier circuit #4

750=OPTO DIP #5

751=Rectifier circuit #5

760=OPTO DIP #6

761=Rectifier circuit #6

770=OPTO DIP #7

771=Rectifier circuit #7

800=FIG. 8 generally comprising two laser beams 810, 820 reading from or writing to rotating disk 830

810=Laser beam number 1

812=Outgoing laser beam number 1

815=Deflected laser beam

820=Laser beam number 2

822=Outgoing laser beam number 2

824=Reflected laser beam

830=Rotating disk

840=Transparent plastic layer

850=Digital information layer

860=Protective layer

Definitions and Acronyms

A great care has been taken to use words with their conventional dictionary definitions. Following definitions are included here for clarification.

3D=Three Dimensional

CD=Compact Disc

DIY=Do It Yourself

DVD=Digital Video Disk

Integrated=Combination of two entities to act like one

Interface=Junction between two dissimilar entities

LCD=Liquid Crystal Display

LED=Light Emitting Diode

OEM=Original Equipment Manufacturer

RPM=Revolutions Per Minute

While this invention has been described with reference to illustrative embodiments, this description is not intended to be construed in a limiting sense. Various modifications and combinations of the illustrative embodiments as well as other embodiments of the invention will be apparent to a person of average skill in the art upon reference to this description. It is therefore contemplated that the appended claim(s) cover any such modifications, embodiments as fall within the true scope of this invention.

1. A compact disk restoration system comprising:
a) a rotating circular compact disk platter;
b) at least one rotating buffer pad tangentially in contact with said rotating disk platter;
c) means for traversing said buffer pad along the radius of said rotating disk platter; and
d) spring means for adjusting interface tangential tension between said rotating platter and said buffer pad.

2. The compact disk restoration system of claim 1 wherein nothing is removed from the CD such that the thickness of the CD remains constant unchanged during the buffing operation.

3. The compact disk restoration system of claim 1 wherein nothing is added to the CD such that the thickness of the CD remains constant unchanged during the buffing operation.

4. A compact disk restoration method comprising the steps of:
a) loading a damaged compact disc onto an on-demand uniformly rotateable platter;
b) applying coolant onto optical side of said compact disc;
c) buffing said optical side of said compact disc with tangentially touching rotating pads; and
d) removing said compact disc from said platter for immediate restored use.

5. The compact disk restoration method of claim 4 wherein nothing is removed from the CD such that the thickness of the CD remains constant unchanged during the buffing operation.

6. The compact disk restoration method of claim 4 wherein nothing is added to the CD such that the thickness of the CD remains constant unchanged during the buffing operation.

7. The compact disk restoration method of claim 3 wherein buffing comprises smooth agitation so as to reflow polymer plastic on said CD to proper optical flatness plane of said CD prior to said restoration process.

8. The compact disk restoration method of claim 4 wherein different levels of coolant concentration are applied to consecutive pads of said buffer.

9. The compact disk restoration method of claim 4 wherein the buffer motor is rotating in the same direction as the recorded media.

10. The compact disk restoration method of claim 4 further comprising deep buffing by doubling the buffing time resulting in triple effectiveness.
